(19) United States
(12) Patent Application Publication
(10) Pub. No.: US 2018/0174384 A1
(43) Pub. Date: Jun. 21, 2018

(54) Time-Limit Door Access Control Management System With Guest Authentication, And Method Thereof

(71) Applicants: Inventec (Pudong) Technology Corporation, Shanghai (CN); Inventec Corporation, Taipei city (TW)

(72) Inventor: Chaucer Chiu, Taipei (TW)

(21) Appl. No.: 15/622,848

(22) Filed: Jun. 14, 2017

(30) Foreign Application Priority Data
Dec. 21, 2016 (CN) 201611191961.0

(51) Int. Cl. G07C 9/00; G06K 7/14

(52) U.S. Cl. CPC G07C 9/00007; G06K 7/1417

(57) ABSTRACT

The present disclosure illustrates a time-limit door access control management system with guest authentication and a method thereof. In the system, guest information is created in a management server through a client. A two-dimensional barcode containing the guest information is transmitted to a guest handheld device. The guest may use the guest handheld device to enable the management server to perform authentication on the to-be-authenticated guest information in the management server through a security management device and create door access control management information. The guest is allowed to pass the door access control device by using the guest handheld device within a time limit. Therefore, the system and method may achieve the technical effect of improving efficiency and convenience of door access control management.

### CROSS-REFERENCE TO RELATED APPLICATION

This application claims the benefit of Chinese Patent Application No. 201611191961.0, filed Dec. 21, 2016.

### BACKGROUND OF THE INVENTION

### Field of the Invention

The present disclosure relates to a door access control management system and a method thereof, more particularly to a door access control management system with guest authentication and time-limit management, and a method thereof.

### Description of the Related Art

In recent years, there are several door access control management manners for commercial building, such as manual door access control management, semi-electronic door access control management, and electronic door access control management.

In the manual door access control management manner, security guards completely manage door access control for comings and goings; however, it is impossible for security guards to manage and control access of all people, so the manual door access control management manner may have a risk of management loopholes in personnel access control.

In the semi-electronic door access control management manner, a guest is required to obtain an access card from the security guard to pass a specific door access control device; however, some guests may forget to return the access card after visit, which may result in problems of more access card consumption and more cost in building up the access control system.

In the electronic door access control management manner, the guest does not need to obtain the access card from the security guard, but the visited company must send someone to lead the guest to pass the door access control, it also troubles the visited company.

As a result, what is need is to develop a door access control management system to solve aforementioned problem that the existing access control management is inconvenient.

### SUMMARY OF THE INVENTION

In order to solve aforementioned problem of inconvenience in door access control management, the present disclosure is to provide a time-limit door access control management system with guest authentication, and a method thereof.

According to an embodiment, a time-limit door access control management system with guest authentication includes a client, a management server, a security management device and a door access control device. The client may include a first receiving module, a generating module and a first transmitting module. The management server may include a second receiving module, a storage module, an authentication module and a second transmitting module. The security management device may include an image capturing module, a decoding module, a third transmitting module, a third receiving module and a door access control management module. The door access control device may include a fourth receiving module, a fourth transmitting module and a door access control module.

The first receiving module of the client is configured to receive guest personal information. The generating module of the client is configured to generate guest information according to the guest personal information and client information, and generate a two-dimensional barcode according to the guest information. The first transmitting module of the client is configured to transmit the guest information, and transmit the two-dimensional barcode to a guest handheld device.

The second receiving module of the management server is configured to receive the guest information from the first transmitting module, to-be-authenticated guest information, door access control management information, a to-be-authenticated identifier and a door access control management identifier. The storage module of the management server is configured to store the guest information and the door access control management information. The authentication module of the management server is configured to perform authentication on the to-be-authenticated guest information according to the stored guest information, and generate an authentication pass response when the to-be-authenticated guest information passes the authentication; and perform authentication on the to-be-authenticated identifier and the door access control management identifier according to the stored door access control management information, and generate an unlock instruction when the to-be-authenticated identifier and the door access control management identifier pass the authentication and a system time is within a visit time period of the door access control management information. The second transmitting module of the management server is configured to transmit the authentication pass response, and transmit the unlock instruction.

The image capturing module of the security management device is configured to capture the two-dimensional barcode displayed on the guest handheld device. The decoding module of the security management device is configured to decode the two-dimensional barcode to obtain the to-be-authenticated guest information. The third transmitting module of the security management device is configured to transmit the to-be-authenticated guest information to the second receiving module, and transmit the door access control management information. The third receiving module of the security management device is configured to receive the authentication pass response from the second transmitting module, and receive a unique identifier of the guest handheld device from the guest handheld device. The door access control management module of the security management device is configured to create the door access control management information including the unique identifier, the visit time period and at least one door access control management identifier of the guest information, which correspond to each other, when the third receiving module receives the authentication pass response.

The fourth receiving module of the door access control device is configured to receive the to-be-authenticated identifier, and receive the unlock instruction from the second transmitting module. The fourth transmitting module of the door access control device is configured to transmit the to-be-authenticated identifier and the door access control management identifier to the second receiving module. The door access control module of the door access control device is temporarily unlock a controlled door when the fourth receiving module receives the unlock instruction.

According to an embodiment, the time-limit door access control management method with guest authentication includes following steps: first, providing a client to receive guest personal information; next, in the client, generating guest information according to the guest personal information and client information, and generating a two-dimensional barcode according to the guest information; transmitting the guest information from the client to a management server; transmitting the two-dimensional barcode from the client to a guest handheld device having a unique identifier; storing the guest information in the management server; in a security management device, capturing the two-dimensional barcode displayed on the guest handheld device; in the security management device, decoding the two-dimensional barcode to obtain to-be-authenticated guest information, and transmitting the to-be-authenticated guest information to the management server; in the management server, performing authentication on the to-be-authenticated guest information according to the stored guest information, and generating an authentication pass response after the to-be-authenticated guest information is authenticated; transmitting the authentication pass response from the management server to the security management device, and in the security management device, creating door access control management information including the unique identifier, a visit time period and at least one door access control management identifier of the guest information, which correspond to each other; transmitting the door access control management information from the security management device to the management server; storing the door access control management information in the management server; in a door access control device having the door access control management identifier, receiving the unique identifier of the guest handheld device from the guest handheld device, using the unique identifier as a to-be-authenticated identifier, and transmitting the to-be-authenticated identifier and the door access control management identifier to the management server; in the management server, performing authentication on the to-be-authenticated identifier and the door access control management identifier according to the stored door access control management information, and generating an unlock instruction after the to-be-authenticated identifier and the door access control management identifier are authenticated and a system time is within the visit time period of the door access control management information; and transmitting the unlock instruction from the management server to the door access control device, and unlocking a controlled door temporarily, by the door access control device.

According to aforementioned time-limit door access control management system and method of the present disclosure, the difference between the present disclosure and the conventional technology is that, in the system and method of the present disclosure, the guest information is created in the management server through the client, and the guest information is converted into a two-dimensional barcode which is then transmitted to the guest handheld device, so that the guest may use the guest handheld device to perform the identification authentication in the management server through the security management device and the door access control management information is created, and the guest may use the guest handheld device to pass the permitted door access control device in the time-limit period.

Therefore, by the technical means of the present disclosure, the technical effect of improving the convenience in door access control management may be achieved.

### BRIEF DESCRIPTION OF THE DRAWINGS

The structure, operating principle and effects of the present disclosure will be described in detail by way of various embodiments which are illustrated in the accompanying drawings.

FIG. 1 is a system block diagram of a time-limit door access control management system with guest authentication, in accordance with the present disclosure.

FIGS. 2A-2C are flowcharts showing the steps in an operation of a time-limit door access control management method with guest authentication, accordance with the present disclosure.

FIG. 3 is an architecture view of the time-limit door access control management system with guest authentication, accordance with the present disclosure.

### DETAILED DESCRIPTION OF THE PREFERRED EMBODIMENTS

The following embodiments of the present invention are herein described in detail with reference to the accompanying drawings. These drawings show specific examples of the embodiments of the present invention. It is to be understood that these embodiments are exemplary implementations and are not to be construed as limiting the scope of the present invention in any way. Further modifications to the disclosed embodiments, as well as other embodiments, are also included within the scope of the appended claims. These embodiments are provided so that this disclosure is thorough and complete, and fully conveys the inventive concept to those skilled in the art. Regarding the drawings, the relative proportions and ratios of elements in the drawings may be exaggerated or diminished in size for the sake of clarity and convenience. Such arbitrary proportions are only illustrative and not limiting in any way. The same reference numbers are used in the drawings and description to refer to the same or like parts.

It is to be understood that, although the terms ‘first’, ‘second’, ‘third’, and so on, may be used herein to describe various elements, these elements should not be limited by these terms. These terms are used only for the purpose of distinguishing one component from another component. Thus, a first element discussed herein could be termed a second element without altering the description of the present invention. As used herein, the term “or” includes any and all combinations of one or more of the associated listed items.

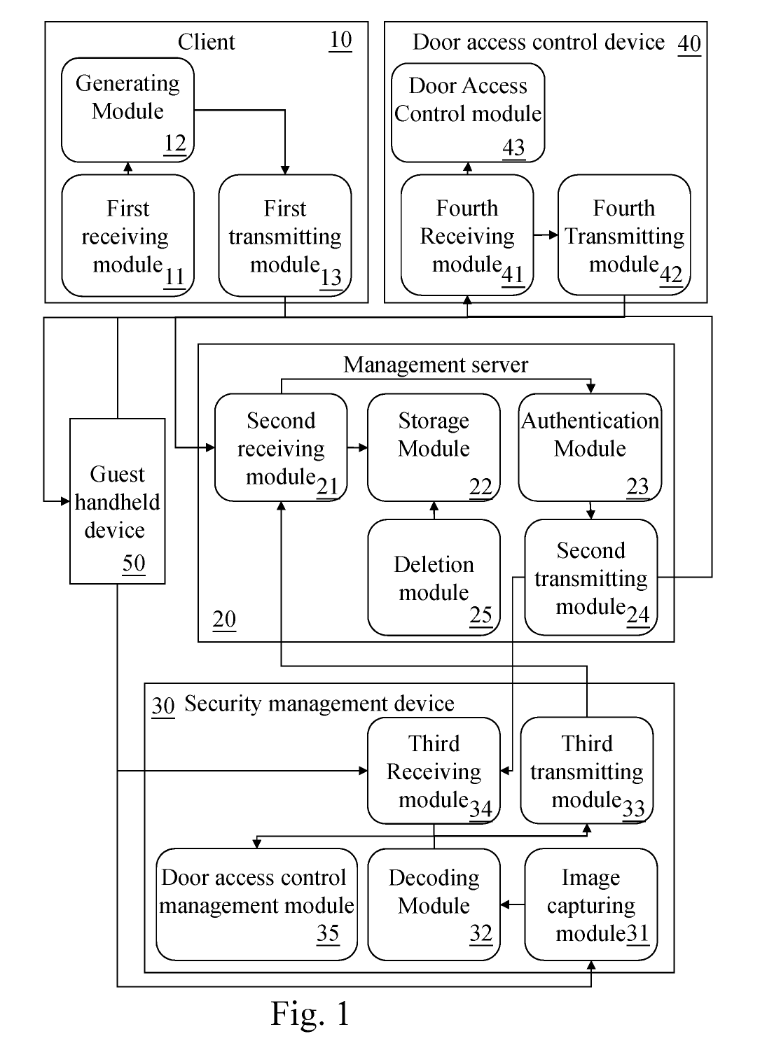

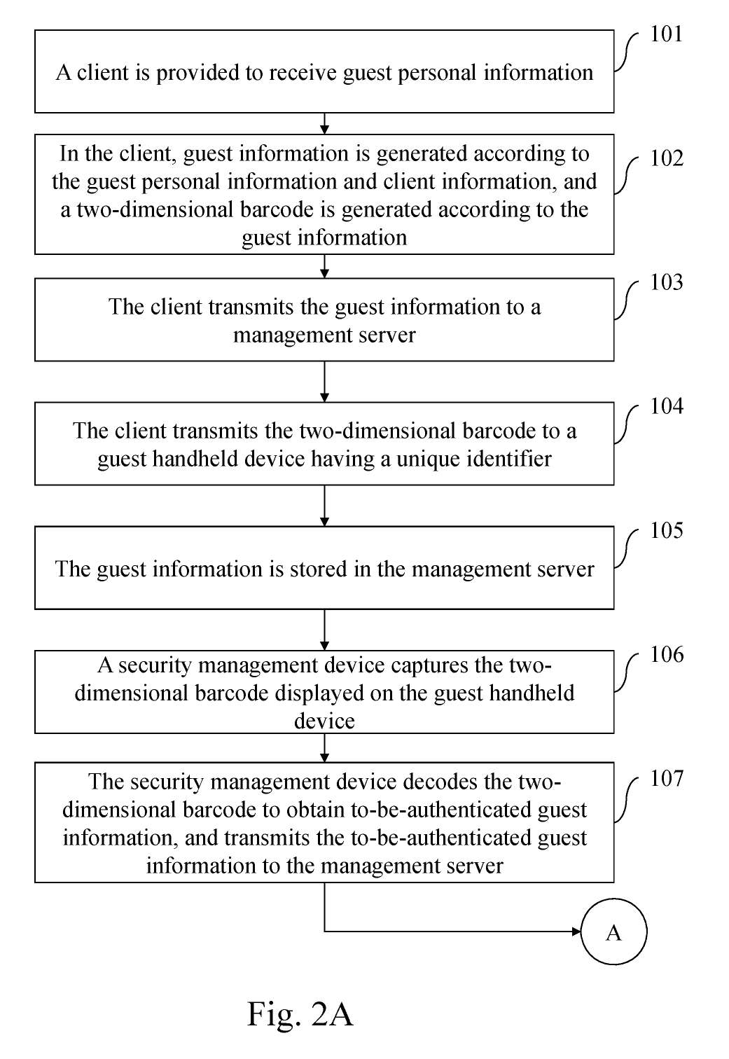

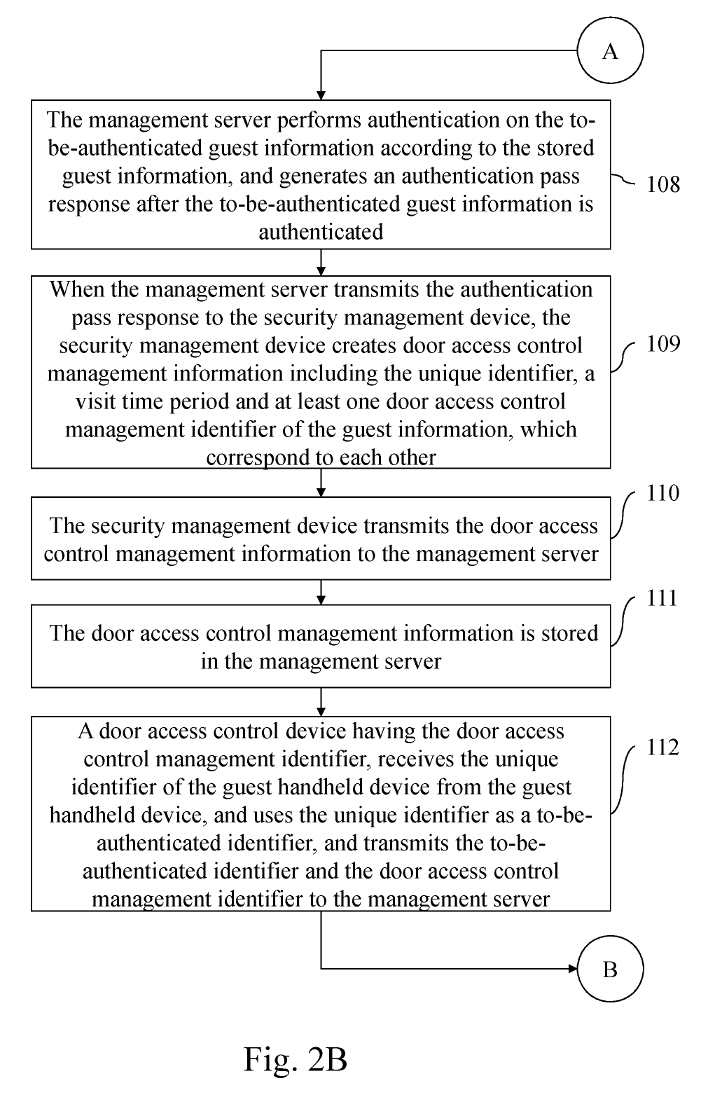

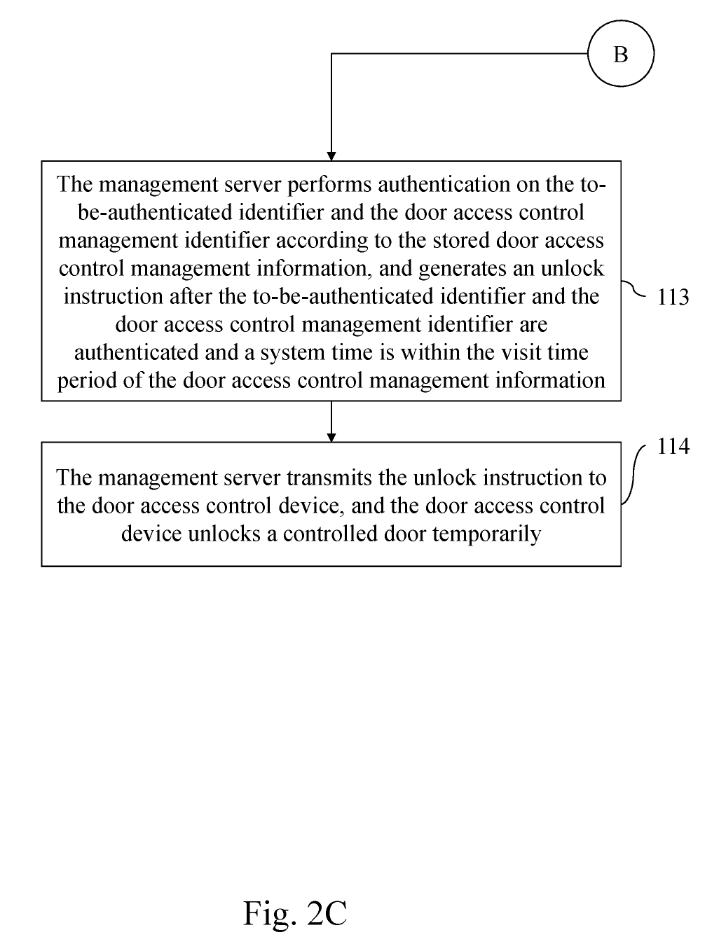

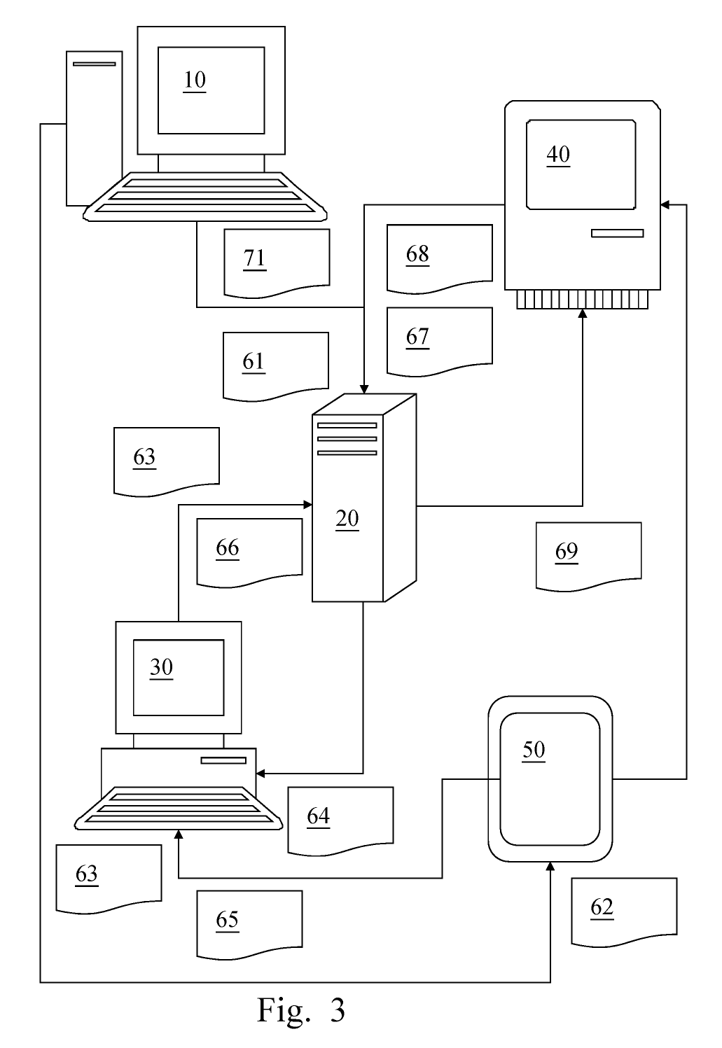

The following describes an embodiment for illustration of implementing the system and method of the present disclosure. Please refer to FIGS. 1, 2A-2C, and 3. FIG. 1 is a block diagram of the time-limit door access control management system with guest authentication, in accordance with the present disclosure; FIGS. 2A-2C are flowcharts showing the steps in an operation of the time-limit door access control management method with guest authentication, in accordance with the present disclosure; and FIG. 3 is an architecture view of the time-limit door access control management system with guest authentication, in accordance with the present disclosure.

The time-limit door access control management system includes a client 10, a management server 20, a security management device 30 and a door access control device 40. The client 10 may include a first receiving module 11, a generating module 12 and a first transmitting module 13. The management server 20 may include a second receiving module 21, a storage module 22, an authentication module 23 and a second transmitting module 24. The security management device 30 may include an image capturing module 31, a decoding module 32, a third transmitting module 33, a third receiving module 34 and a door access control management module 35. The door access control device 40 may include a fourth receiving module 41, a fourth transmitting module 42 and a door access control module 43.

Before a guest visits a company, a staff of the visited company may input the guest personal information through a user interface provided by a client 10 disposed in the company. The guest personal information may include the guest's name, ID number, email, telephone number, a visit time period and so on; however, these examples are merely for exemplary illustration, and the application field of the present disclosure is not limited thereto. Preferably, the client 10 may be a computer, a notebook computer, a tablet computer, a smart device, and so on; however, these examples are merely for exemplary illustration, and the application field of the present disclosure is not limited thereto.

In a step 101, after the guest personal information is inputted through the user interface provided by the client 10, the first receiving module 11 of the client 10 receives the guest personal information. Next, in a step 102, the generating module 12 of the client 10 generates guest information 61 according to the guest personal information and the client information, and then generates a two-dimensional barcode 62 according to the guest information. The client information is pre-built in the client 10, and may include a company name, a company number, a door access control management identifier for reaching the company, and so on; however, these examples are merely for exemplary illustration, the application field of the present disclosure is not limited thereto.

In a step 103, after the generating module 12 of the client 10 generates the guest information 61 according to the guest personal information and the client information and generates the two-dimensional barcode 62 according to the guest information 61, the client 10 is linked with the management server 20 and a guest handheld device 50 by a wired or wireless transmission manner, and the first transmitting module 13 of the client 10 transmits the guest information 61 to the management server 20. Preferably, the wired transmission manner may include cable network, optical fiber network, and so on; the wireless transmission manner may include Wi-Fi, 3G, 4G and so on; however, these examples are merely for exemplary illustration, and the application field of the present disclosure is not limited thereto. Next, in a step 104, the first transmitting module 13 of the client 10 transmits the two-dimensional barcode 62 to the guest handheld device 50. Preferably, the guest handheld device 50 may include a smartphone, a personal digital assistant (PDA), and so on; however, these examples are merely for exemplary illustration, and the application field of the present disclosure is not limited thereto.

In a step 105, after the second receiving module 21 of the management server 20 receives the guest information 61 from the first transmitting module 13 of the client 10, the storage module 22 of the management server 20 stores the guest information 61 received by the second receiving module 21 of the management server 20.

The guest handheld device 50 may receive the two-dimensional barcode 62 from the first transmitting module 13 of the client 10. When the guest visits the company, in a building management office the guest may use the two-dimensional barcode 62 obtained from the client 10 to perform authentication and build door access control management. The security management device 30 may be disposed in the building management office, and includes an image capturing module 31 to capture the two-dimensional barcode 62 displayed on the guest handheld device 50 (in a step 106).

After the image capturing module 31 of the security management device 30 captures the two-dimensional barcode displayed on the guest handheld device 50, the decoding module 32 of the security management device 30 decodes the two-dimensional barcode to obtain to-be-authenticated guest information 63, and the security management device 30 is linked with the management server 20 by the wired or wireless transmission manner, and the third transmitting module 33 of the security management device 30 transmits the to-be-authenticated guest information 63 to the management server 20 (in a step 107). Preferably, the wired transmission manner may include cable network, optical fiber network, and so on; the wireless transmission manner may include Wi-Fi, 3G, 4G and so on; however, these examples are merely for exemplary illustration, and the application field of the present disclosure is not limited thereto.

In a step 108, the second receiving module 21 of the management server 20 may receive the to-be-authenticated guest information 63 from the third transmitting module 33 of the security management device 30, and the authentication module 23 of the management server 20 performs authentication on the to-be-authenticated guest information 63 according to the stored guest information 61, that is, the authentication module 23 of the management server 20 compares whether the to-be-authenticated guest information 63 matches the stored guest information 61. When the to-be-authenticated guest information 63 matches the stored guest information 61, it indicates that the to-be-authenticated guest information 63 passes authentication of the authentication module 23 of the management server 20, and the authentication module 23 of the management server 20 generates an authentication pass response 64.

After the authentication module 23 of the management server 20 generates the authentication pass response 64, the second transmitting module 24 of the management server 20 transmits the authentication pass response 64, which is generated by the authentication module 23 of the management server 20, to the security management device 30.

The third receiving module 34 of the security management device 30 receives the authentication pass response 64 from the second transmitting module 24 of the management server 20. When the third receiving module 34 of the security management device 30 receives the authentication pass response 64, it indicates that the to-be-authenticated guest information 63 passes authentication of the management server 20, and the third receiving module 34 of the security management device 30 may further receive an unique identifier 65 of the guest handheld device 50 from the guest handheld device 50. Preferably, the wired transmission manner may be a transmission cable, and so on; the wireless transmission manner may include Wi-Fi, Bluetooth, RFID, and near field communication (NFC) and so on; however, these examples are merely for exemplary illustration, and the application field of the present disclosure is not limited thereto. Preferably, the unique identifier 65 may be International Mobile Equipment Identity (IMEI), manufacture serial number, and so on; however, the examples are merely for exemplary illustration, and the application field of the present disclosure is not limited thereto.

In a step 109, after the third receiving module 34 of the security management device 30 receives the unique identifier 65 from the guest handheld device 50, the door access control management module 35 of the security management device 30 may create door access control management information 66 including the unique identifier 65, the visit time period and at least one door access control management identifier of the guest information, which correspond to each other. The door access control management identifier is obtained from the client information of the guest information.

In a step 110, after the door access control management module 35 of the security management device 30 creates the door access control management information 66 including the unique identifier 65 and the visit time period and at least one door access control management identifier of the guest information, which correspond to each other, the third transmitting module 33 of the security management device 30 transmits the door access control management information 66 to the management server 20.

In a step 111, the second receiving module 21 of the management server 20 receives the door access control management information 66 from the third transmitting module 33 of the security management device 30, and the storage module 22 of the management server 20 stores the door access control management information 66.

When the guest holds and moves the guest handheld device 50 close to the door access control device 40, the door access control device 40 and the guest handheld device 50 are interconnected with each other by the wireless transmission manner (such as Wi-Fi, Bluetooth, RFID, NFC and so on; however, these examples are merely for exemplary illustration, and the application field of the present disclosure is not limited thereto), and the fourth receiving module 41 of the door access control device 40 receives the unique identifier of the guest handheld device 50 from the guest handheld device 50, and the door access control device 40 uses the unique identifier as a to-be-authenticated identifier 67.

In a step 112, after the fourth receiving module 41 of the door access control device 40 receives the to-be authenticated identifier 67 from the guest handheld device 50, the door access control device 40 is interconnected with the management server 20 through the wired or wireless transmission manner, so that the fourth transmitting module 42 of the door access control device 40 may transmit the to-be-authenticated identifier 67 received by the fourth receiving module 41 of the door access control device 40 and the door access control management identifier 68 of the door access control device 40 to the management server 20. Preferably, the wired transmission manner may include cable network, optical fiber network and so on; the wireless transmission manner may include Wi-Fi, 3G, 4G, and so on; however, these examples are merely for exemplary illustration, and the application field of the present disclosure is not limited thereto.

In a step 113, after the second receiving module 21 of the management server 20 receives the to-be-authenticated identifier 67 and the door access control management identifier 68 from the fourth transmitting module 42 of the door access control device 40, the authentication module 23 of the management server 20 performs authentication on the to-be-authenticated identifier 67 and the door access control management identifier 68 according to the stored door access control management information 66. That is, the authentication module 23 of the management server 20 compares whether the to-be-authenticated identifier 67 and the door access control management identifier 68 respectively match the unique identifier 65 and the door access control management identifier contained in the stored door access control management information 66. When the to-be-authenticated identifier 67 and the door access control management identifier 68 respectively match the unique identifier 65 and the door access control management identifier contained in the stored door access control management information 66, it indicates that the to-be-authenticated unique identifier 65 and the door access control management identifier 68 pass the authentication of the authentication module 23 of the management server 20, and if the system time of the management server 20 is also within the visit time period of the door access control management information 66, the authentication module 23 of the management server 20 generates an unlock instruction 69.

After the authentication module 23 of the management server 20 generates the unlock instruction 69, the second transmitting module 24 of the management server 20 transmits the unlock instruction 69 to the door access control device 40, and the fourth receiving module 41 of the door access control device 40 receives the unlock instruction 69 from the second transmitting module 24 of the management server 20.

In a step 114, after the fourth receiving module 41 of the door access control device 40 receives the unlock instruction 69, the door access control module 43 of the door access control device 40 temporarily unlock the controlled door, so that the guest may hold the guest handheld device 50 to pass the door access control device 40 which is permitted, within the visit time period set in advance.

The management server 20 may include a deletion module 25. When a system time of the management server 20 exceeds an upper limit value of the visit time period of the door access control management information 66 plus a predetermined time interval, the deletion module 25 may delete the piece of door access control management information 66. For example, suppose that the visit time period of the door access control management information is in a range of 13:00 to 15:00, and the predetermined time interval is one hour.

When the upper limit value of the visit time period (that is, 15:00) plus one hour is 16:00, if the system time of the management server 20 is 15:30, the management server 20 may determine that the it does not exceed the visit time period, so that the deletion module 25 of the management server 20 does not delete the door access control management information.

When the upper limit value of the visit time period (that is, 15:00) plus one hour is 16:00, if the system time of the management server 20 is 16:30, the management server 20 may determine that it exceeds the visit time period, so that the deletion module 25 of the management server 20 deletes the door access control management information.

When the system time exceeds the visit time period, time-limit extension information may be inputted through the user interface provided by the client 10, and the first receiving module 11 of the client 10 may receive the unique identifier 65 from the guest handheld device 50 and receive the time-limit extension information from the user interface of the client 10 by a wireless transmission manner which includes Wi-Fi, Bluetooth, RFID, NFC and so on; however, these examples are merely for exemplary illustration, and the application field of the present disclosure is not limited thereto.

After the first receiving module 11 of the client 10 receives the unique identifier and the time-limit extension information, the generating module 12 of the client 10 generates guest time-limit extension information 71 according to the unique identifier, the client information and the time-limit extension information, and the first transmitting module 13 of the client 10 transmits the guest time-limit extension information 71 to the management server 20, and the second receiving module 21 of the management server 20 may receive the guest time-limit extension information 71 from the first transmitting module 13 of the client 10.

After the second receiving module 21 of the management server 20 receives the guest time-limit extension information 71, the authentication module 23 of the management server 20 performs authentication on the guest time-limit extension information 71 according to the stored guest information 61 and the door access control management information 66, that is, the authentication module 23 of the management server 20 compares whether the client information of the stored guest information 61 matches the client information of the guest time-limit extension information 71, and compares whether the unique identifier 65 of the stored door access control management information 66 matches the unique identifier of the guest time-limit extension information 71. When the client information of the stored guest information 61 matches the client information of the guest time-limit extension information 71, and the unique identifier 65 of the stored door access control management information 66 matches the unique identifier of the guest time-limit extension information 71, it indicates that the guest time-limit extension information 71 passes authentication of the authentication module 23 of the management server 20, so the storage module 22 of management server 20 updates the visit time period of the stored door access control management information 66 according to the unique identifier and the time-limit extension information of the guest time-limit extension information 71, thereby extending the visit period to keep effective door access control for the guest.

To summarize, the difference between the present disclosure and the conventional technology is that, in the time-limit door access control management system and method of the present disclosure, the guest information is created in the management server through the client, and the guest information is converted into a two-dimensional barcode which is then transmitted to the guest handheld device, so that the guest may use the guest handheld device to perform the identification authentication in the management server through the security management device and the door access control management information is created, and the guest may use the guest handheld device to pass the permitted door access control device in the time-limit period.

Therefore, the technical means of the present disclosure may solve the conventional technology problem of inconvenience in door access control management, and further achieve the technical effect of improving the convenience in door access control management.

The present disclosure disclosed herein has been described by means of specific embodiments. However, numerous modifications, variations and enhancements can be made thereto by those skilled in the art without departing from the spirit and scope of the invention set forth in the claims.

What is claimed is:

1. A time-limit door access control management system with guest authentication, comprising:
a client comprising:
a first receiving module configured to receive guest personal information;
a generating module configured to generate guest information according to the guest personal information and client information, and generate a two-dimensional barcode according to the guest information; and
a first transmitting module configured to transmit the guest information, and transmit the two-dimensional barcode to a guest handheld device;
a management server comprising:
a second receiving module configured to receive the guest information from the first transmitting module, to-be-authenticated guest information, door access control management information and an to-be-authenticated identifier;
a storage module configured to store the guest information and the door access control management information;
an authentication module configured to perform authentication on the to-be-authenticated guest information according to the stored guest information, and generate an authentication pass response when the to-be-authenticated guest information passes the authentication, and then perform authentication on the to-be-authenticated identifier and the door access control management identifier according to the stored door access control management information, and generate an unlock instruction when the to-be-authenticated identifier and the door access control management identifier pass the authentication and a system time is within a visit time period of the door access control management information; and
a second transmitting module configured to transmit the authentication pass response, and transmit the unlock instruction;
a security management device comprising:
an image capturing module configured to capture the two-dimensional barcode displayed on the guest handheld device;
a decoding module configured to decode the two-dimensional barcode to obtain the to-be-authenticated guest information;
a third transmitting module configured to transmit the to-be-authenticated guest information to the second receiving module, and transmit the door access control management information;
a third receiving module configured to receive the authentication pass response from the second transmitting module, and receive a unique identifier of the guest handheld device from the guest handheld device; and
a door access control management module, configured to create the door access control management information including the unique identifier, the visit time period and at least one door access control management identifier of the guest information, which correspond to each other, when the third receiving module receives the authentication pass response; and
a door access control device having the door access control management identifier, and comprising:
a fourth receiving module configured to receive the to-be-authenticated identifier, and receive the unlock instruction from the second transmitting module;
a fourth transmitting module configured to transmit the to-be-authenticated identifier and the door access control management identifier to the second receiving module; and
a door access control module, temporarily unlock a controlled door when the fourth receiving module receives the unlock instruction.

2. The time-limit door access control management system according to claim 1, wherein the management server further comprises a deletion module configured to delete the door access control management information when it exceeds a predetermined time interval plus an upper limit value of the visit time period of the door access control management information.

3. The time-limit door access control management system according to claim 1, wherein the first receiving module further receives the unique identifier and time-limit extension information, and the generating module generates guest time-limit extension information according to the unique identifier, the client information and the time-limit extension information, and the first transmitting module transmits the guest time-limit extension information to the second receiving module, and the authentication module perform authentication on the guest time-limit extension information according to the stored guest information and the door access control management information, and the storage module update the door access control management information according to the unique identifier and the time-limit extension information of the guest time-limit extension information after the guest time-limit extension information passes authentication of the authentication module.

4. The time-limit door access control management system according to claim 1, wherein the first, second, third and fourth receiving modules respectively receive the information, response or instruction through a wired or wireless transmission manner.

5. A time-limit door access control management method with guest authentication, comprising:
providing a client to receive guest personal information;
in the client, generating guest information according to the guest personal information and client information, and generating a two-dimensional barcode according to the guest information;
transmitting the guest information from the client to a management server;
transmitting the two-dimensional barcode from the client to a guest handheld device having a unique identifier;
storing the guest information in the management server;
in a security management device, capturing the two-dimensional barcode displayed on the guest handheld device;
in the security management device, decoding the two-dimensional barcode to obtain to-be-authenticated guest information, and transmitting the to-be-authenticated guest information to the management server;
in the management server, performing authentication on the to-be-authenticated guest information according to the stored guest information, and generating an authentication pass response after the to-be-authenticated guest information is authenticated;
transmitting the authentication pass response from the management server to the security management device, and in the security management device, creating door access control management information including the unique identifier, a visit time period and at least one door access control management identifier of the guest information, which correspond to each other;
transmitting the door access control management information from the security management device to the management server;
storing the door access control management information in the management server;
in a door access control device having the door access control management identifier, receiving the unique identifier of the guest handheld device from the guest handheld device, using the unique identifier as a to-be-authenticated identifier, and transmitting the to-be-authenticated identifier and the door access control management identifier to the management server;
in the management server, performing authentication on the to-be-authenticated identifier and the door access control management identifier according to the stored door access control management information, and generating an unlock instruction after the to-be-authenticated identifier and the door access control management identifier are authenticated and a system time is within the visit time period of the door access control management information; and
transmitting the unlock instruction from the management server to the door access control device, and unlocking a controlled door temporarily, by the door access control device.

6. The time-limit door access control management method according to claim 5, further comprising:
when the system time exceeds a predetermined time interval plus an upper limit value of the visit time period of the door access control management information, deleting the door access control management information by the management server.

7. The time-limit door access control management method according to claim 5, further comprising:
in the client, receiving the unique identifier and time-limit extension information;
in the client, generating guest time-limit extension information according to the unique identifier, the client information and the time-limit extension information;
transmitting the guest time-limit extension information from the client to the management server;
in the management server, performing authentication on the guest time-limit extension information according to the stored guest information and the door access control management information; and
after the guest time-limit extension information is authenticated, the management server updates the door access control management information according to the unique identifier and the guest time-limit extension information of the guest time-limit extension information.

8. The time-limit door access control management method according to claim 5, wherein the client, the management server, the guest handheld device, the security management device and the door access control device respectively receive information, response or instruction through a wired or wirelessly transmission manner.
